(19) United States
(12) Patent Application Publication
(10) Pub. No.: US 2024/0029953 A1
(43) Pub. Date: Jan. 25, 2024

(54) INDUCTOR COMPONENT AND METHOD FOR MANUFACTURING SAME

(71) Applicant: Murata Manufacturing Co., Ltd., Kyoto-fu (JP)

(72) Inventor: Keisuke KUNIMORI, Nagaokakyo-shi (JP)

(73) Assignee: Murata Manufacturing Co., Ltd., Kyoto-fu (JP)

(21) Appl. No.: 18/351,160

(22) Filed: Jul. 12, 2023

(30) Foreign Application Priority Data
Jul. 21, 2022 (JP) 2022-116148

(51) Int. Cl. H01F 41/12; H01F 27/28; H01F 27/32; H01F 41/34; H01F 27/02

(52) U.S. Cl. CPC H01F 41/127; H01F 27/2823; H01F 27/32; H01F 41/34; H01F 27/02

(57) ABSTRACT

An inductor component capable of improving an inductance value and a method for manufacturing the same. An inductor component includes a base layer having a main surface; a coil wiring formed on the main surface of the base layer; an insulating layer covering the coil wiring; and a magnetic layer covering the insulating layer. A shape of the insulating layer in a section perpendicular to the main surface of the base layer is a trapezoidal shape in which a width of a first end surface on a side opposite to the base layer is narrower than a width of a second end surface on the base layer side, and the width of the first end surface is narrower than a width of a formation area of the coil wiring in a direction parallel to the main surface of the base layer.

### CROSS-REFERENCE TO RELATED APPLICATION

This application claims benefit of priority to Japanese Patent Application No. 2022-116148, filed Jul. 21, 2022, the entire content of which is incorporated herein by reference.

### BACKGROUND

### Technical Field

The present disclosure relates to an inductor component and a method for manufacturing the same.

### Background Art

Conventionally, as an inductor component, there is an inductor component in which a coil wiring is formed by electrolytic plating on a seed layer in a through hole formed by removing a part of an insulating layer by a semi-additive process (SAP) as described, for example, in Japanese Patent No. 6662181.

### SUMMARY

FIG. 9 is a sectional view schematically illustrating a configuration of the conventional inductor component 100. The inductor component 100 has a configuration in which a coil wiring 111 is partitioned by a rectangular resin wall 112a as an insulating layer and formed on a base layer 110, and an insulating layer 112b having a rectangular shape is formed on the upper surfaces of the coil wiring 111 and the resin wall 112a.

In the inductor component 100, a magnetic layer 113 is provided so as to cover the entire coil portion including the coil wiring 111 and the insulating layers 112a and 112b, but the inductance value of the inductor component 100 is improved as the volume of the magnetic layer 113 is larger. However, in the configuration illustrated in FIG. 9, since the width A3 of the insulating layer 112b cannot be made narrower than the width B3 of the formation area of the coil wiring 111, the volume of the insulating layer increases. Therefore, there is a disadvantage that it is difficult to increase the volume of the magnetic layer to improve the inductance value of the inductor component.

Therefore, the present disclosure provides an inductor component capable of improving an inductance value and a method for manufacturing the same.

The present inventors have found that the inductance value of the inductor component can be improved by increasing the volume of the magnetic layer covering the coil portion by making the shape of the insulating layer covering the coil wiring of the inductor component different from the shape of the conventional product, and have completed the present disclosure.

Therefore, an inductor component according to a first aspect of the present disclosure includes a base layer having a main surface; a coil wiring formed on the main surface of the base layer; an insulating layer covering the coil wiring; and a magnetic layer covering the insulating layer. A shape of the insulating layer in a section perpendicular to the main surface of the base layer is a trapezoidal shape in which a width of a first end surface on a side opposite to the base layer is narrower than a width of a second end surface on the base layer side, and the width of the first end surface is narrower than a width of a formation area of the coil wiring in a direction parallel to the main surface of the base layer.

Also, a method for manufacturing an inductor component according to a second aspect of the present disclosure includes a first step of forming a coil wiring on a main surface of a base layer; a second step of forming an insulating layer by disposing a positive-type photosensitive insulating material on the main surface of the base layer so as to cover the coil wiring; and a third step of removing a range of the insulating layer other than a portion covering the coil wiring by photolithography to make a shape of the insulating layer in a section perpendicular to the main surface of the base layer into a trapezoidal shape in which a width of a first end surface on a side opposite to the base layer is narrower than a width of a second end surface on the base layer side, and a width of the first end surface is narrower than a width of a formation area of the coil wiring in a direction parallel to the main surface of the base layer.

In addition, a method for manufacturing an inductor component according to a third aspect of the present disclosure includes a first step of forming a first insulating layer on a main surface of a base layer; a second step of forming a through hole for forming a coil wiring extending in a normal direction of the main surface of the base layer in a tapered shape in which a width of a wall portion of the through hole in a section perpendicular to the main surface of the base layer becomes narrower as a distance from the base layer increases by photolithography in which a focus position of a projection exposure machine is set to be shifted from a surface of the first insulating layer with respect to the first insulating layer; a third step of forming the coil wiring in the through hole; a fourth step of forming a second insulating layer covering the through hole; and a fifth step of forming a lid portion covering the through hole as a tapered shape in which a width of the lid portion in a direction parallel to the main surface of the base layer in a section perpendicular to the main surface of the base layer becomes narrower as a distance from the base layer increases by removing a portion other than a portion of the second insulating layer covering the through hole by photolithography in which a focus position of a projection exposure machine is set to be shifted from a surface of the second insulating layer.

According to the inductor component of the present disclosure, the inductance value can be improved. According to the method for manufacturing an inductor component of the present disclosure, it is possible to manufacture an inductor component having an improved inductance value.

### BRIEF DESCRIPTION OF THE DRAWINGS

FIG. 1 is a sectional view schematically illustrating a configuration of an inductor component according to a first embodiment;

FIG. 2 is an explanatory view of exemplary dimensions of the inductor component according to the first embodiment;

FIG. 3 is a first explanatory view of a method for manufacturing an inductor component according to the first embodiment;

FIG. 4 is a second explanatory view of the method for manufacturing an inductor component according to the first embodiment;

FIG. 5 is a third explanatory view of the method for manufacturing an inductor component according to the first embodiment;

FIG. 6 is a sectional view schematically illustrating a configuration of an inductor component according to a second embodiment;

FIG. 7 is a first explanatory view of a method for manufacturing an inductor component according to the second embodiment;

FIG. 8 is a second explanatory view of the method for manufacturing an inductor component according to the second embodiment; and

FIG. 9 is a sectional view schematically illustrating a configuration of a conventional inductor component.

### DETAILED DESCRIPTION

Hereinafter, aspects of an inductor component and a method for manufacturing the same of the present disclosure will be described in detail with reference to the illustrated embodiments.

### 1. First Embodiment

### (1-1. Configuration)

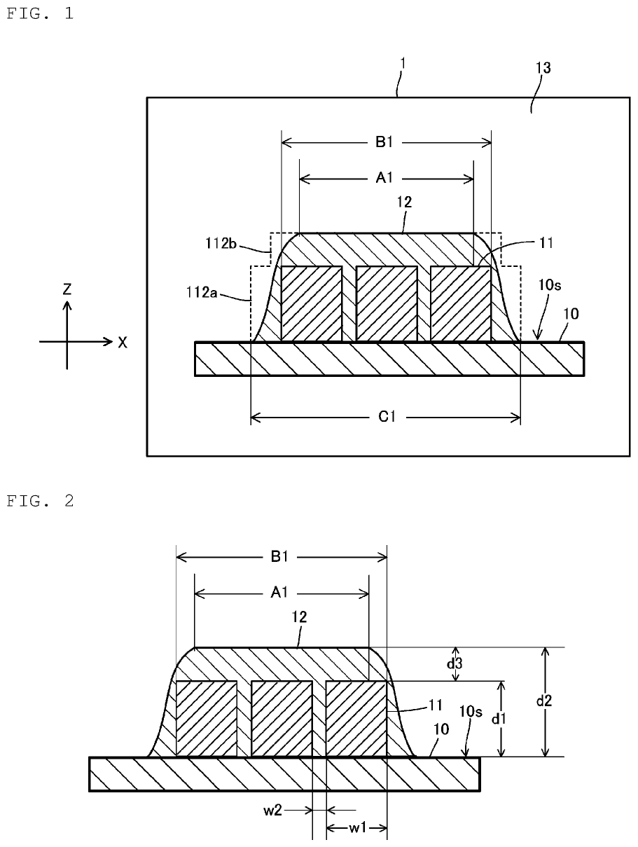

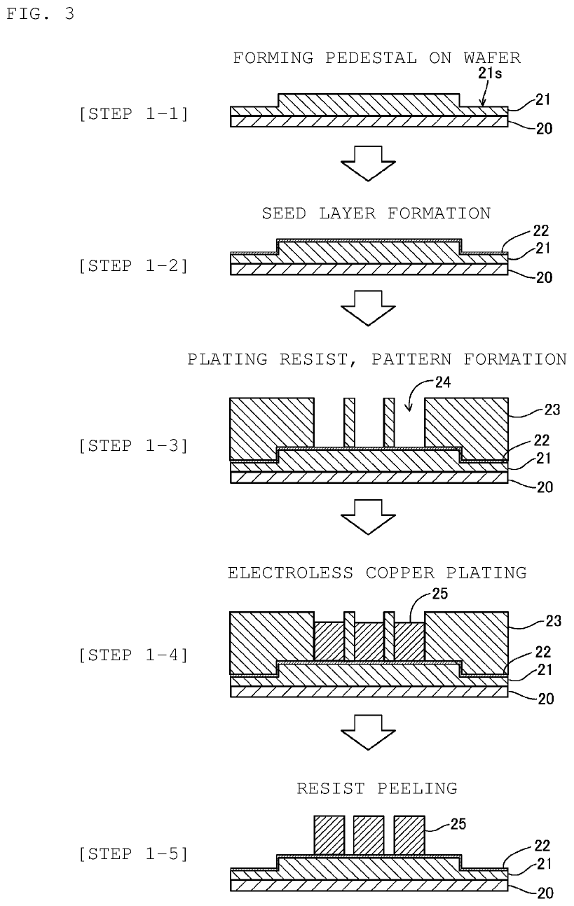

FIGS. 1 and 2 are sectional views schematically illustrating a configuration of an inductor component 1 according to a first embodiment, in which FIG. 1 also illustrates a difference in configuration from a conventional product, and FIG. 2 illustrates dimensions of components. The inductor component 1 is mounted on an electronic device such as a personal computer, a DVD player, a digital camera, a TV, a mobile phone, or car electronics, and is an electronic component having a substantially rectangular parallelepiped shape (hexahedron shape) as a whole. However, the shape of the inductor component 1 is not particularly limited, and may be a columnar shape, a polygonal columnar shape, a truncated cone shape, or a polygonal frustum shape.

As illustrated in FIG. 1, the inductor component 1 includes a base layer 10, a coil wiring 11, an insulating layer 12, and a magnetic layer 13. The coil wiring 11 is connected to an external terminal (not illustrated). In the drawing, a normal direction of a main surface 10s of the base layer 10 is defined as the Z direction, the forward Z direction is defined as the upper side, and the reverse Z direction is defined as the lower side. In FIG. 1, a direction parallel to the main surface 10s of the base layer 10 is defined as the X direction. Note that the section illustrated in FIG. 1 is a section including the center of the inductor component 1 in a direction parallel to the main surface 10s of the base layer 10 and is a section orthogonal to the extending direction of the coil wiring 11. In addition, the forward Z direction, that is, the upper side is a direction from the base layer 10 toward the coil wiring 11.

The coil wiring 11 is formed on the main surface 10s of the base layer 10 so as to extend to the upper side of the base layer 10, and is wound on the base layer 10. The coil wiring 11 has a spiral shape in which the number of turns exceeds one turn. Referring to FIG. 2, the thickness d1 of the coil wiring 11 is, for example, 5 to 100 μm, and the thickness d2 of the insulating layer 12 is, for example, 10 to 140 μm. The thickness d3 of the insulating layer 12 on the upper side of the coil wiring 11 is, for example, 5 to 40 μm. The width w1 of the coil wiring 11 is, for example, 5 to 100 μm, and the inter-line space w2 of the coil wiring 11 is, for example, 5 to 30 μm. The coil wiring 11 is made of a conductive material, for example, a low electric resistance metal material such as Cu, Ag, or Au.

The insulating layer 12 is a layer having a shape covering the coil wiring 11 along the coil wiring 11. The insulating layer 12 is made of an insulating material not containing a magnetic body, and is made of, for example, a resin material such as an epoxy resin, a phenol resin, or a polyimide resin, or an inorganic material such as an oxide film or a nitride film of silicon or aluminum. Since the insulating layer 12 does not contain a magnetic body, conduction between the wirings of the coil wiring 11 can be prevented. Note that the insulating layer 12 preferably does not contain a filler, and in this case, it is possible to reduce the thickness and improve the flatness of the insulating layer 12. On the other hand, when the insulating layer 12 contains a nonmagnetic filler such as silica, the strength, processability, and electrical characteristics of the insulating layer 12 can be improved. As described later, the insulating layer 12 is made of a positive-type photosensitive insulating material.

The magnetic layer 13 is formed so as to cover the base layer 10 on which the coil wiring 11 is formed and the insulating layer 12. In FIGS. 1 and 2, the magnetic layer 13 is transparent. The magnetic layer 13 is made of a magnetic material, for example, a resin containing a powder of a magnetic material. The resin constituting the magnetic layer 13 is, for example, an epoxy-based resin, a phenol-based resin, a polyimide-based resin, or the like, and the powder of the magnetic material is, for example, a powder of a metal magnetic material such as an FeSi-based alloy such as FeSiCr, an FeCo-based alloy, an Fe-based alloy such as NiFe, or an amorphous alloy thereof, or a powder of ferrite or the like. The content of the magnetic material is preferably 50 vol % or more and 85 vol % or less (i.e., from 50 vol % to 85 vol %) with respect to the entire magnetic layer 13. In the magnetic material powder, the particles are preferably substantially spherical, and the average particle diameter is preferably 5 μm or less. Furthermore, the magnetic layer 13 may be a sintered body of ferrite or the like. When the magnetic material is made of resin, it is preferable to use the same kind of material as the insulating layer 12, and in this case, the close contact property between the insulating layer 12 and the magnetic layer 13 can be improved.

The base layer 10 is a layer having the main surface 10s around which the coil wiring 11 is wound, and is formed so as to be included in the magnetic layer 13. The base layer 10 is made of the same material as the insulating layer 12. However, the base layer 10 may be made of the same material as the magnetic layer 13, or may be a sintered body of ferrite in a case where the magnetic layer 13 is a resin containing a powder of a magnetic material. In addition, the base layer 10 may be integrated with the insulating layer 12 or the magnetic layer 13, or may be separated from these layers.

In the inductor component 1, as illustrated in FIG. 1, in the section perpendicular to the main surface 10s of the base layer 10, the insulating layer 12 has a trapezoidal shape in which the width A1 of a first end surface on the upper side (end surface on a side opposite to the base layer 10) is narrower than the width C1 of a second end surface on the lower side (end surface on the base layer 10 side), and the width A1 of the first end surface is narrower than the width B1 of the formation area of the coil wiring 11 in the X direction parallel to the base layer.

By forming the insulating layer 12 of the inductor component 1 in the above shape, the volume of the insulating layer 12 is reduced as compared with the case where the insulating layers 112a and 112b have a rectangular shape as in the conventional inductor component indicated by a dotted line in FIG. 1. Then, the volume of the magnetic layer 13 covering the insulating layer 12 is increased by this decrease. As a result, the inductance value of the inductor component 1 can be improved.

In the inductor component 1, in the section of FIG. 1, the trapezoidal shape of the insulating layer 12 preferably has a curved line or a polygonal line in which two opposing sides connecting the first end surface and the second end surface protrude toward the outside of the insulating layer 12. In this case, the periphery of the insulating layer 12 can be easily filled with the magnetic layer 13.

Further, in the inductor component 1, the coil wiring 11 has a spiral shape exceeding one turn, and in the section of FIG. 1, a difference between the width A1 of the first end surface and the width B1 of the formation area of the coil wiring 11 is preferably larger than the inter-line space w2 of the coil wiring 11. As a result, the volume of the insulating layer 12 can be reduced sufficiently larger than the manufacturing variation of the coil wiring 11, and the inductance value of the inductor component 1 can be more reliably improved. The width A1 of the first end surface is more preferably narrower than the width B1 of the formation area of the coil wiring 11 by 10 μm or more, and the inductance value of the inductor component 1 can be more reliably improved.

In the inductor component 1, in the section of FIG. 1, the difference between the width A1 of the first end surface and the width C1 of the second end surface is preferably larger than the width w 1 of the coil wiring 11. As a result, the volume of the insulating layer 12 corresponding to about one turn of the coil wiring 11 can be reduced. The width A1 of the first end surface is more preferably narrower than the width C1 of the second end surface by 50 μm or more, and the inductance value of the inductor component 1 can be further improved.

### (1-2. Manufacturing Method)

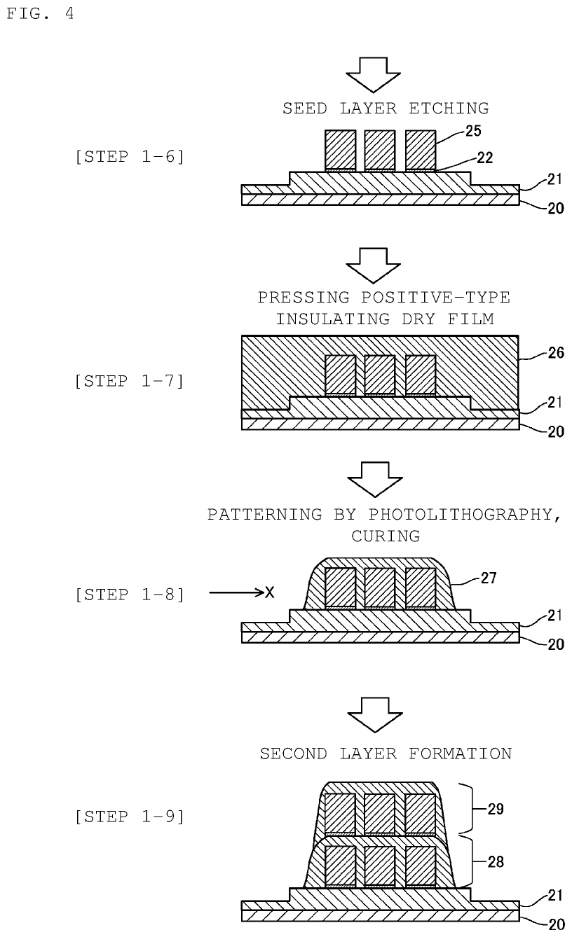

Next, a method for manufacturing the inductor component 1 will be described with reference to FIGS. 3 to 5.

First, as illustrated in step 1-1 of FIG. 3, an insulating pedestal 21 is formed on a substrate (wafer) 20. The substrate 20 is, for example, a flat plate-like substrate made of a ceramic material such as glass or ferrite, a printed wiring board material such as a resin containing glass cloth, or the like. The pedestal 21 is made of, for example, a polyimide-based resin not containing a magnetic body, and is formed on the upper surface of the substrate 20 by photolithography.

In next step 1-2, a Cu seed layer 22 is formed on a main surface 21s of the pedestal 21 by sputtering, electroless plating, or the like. In next step 1-3, a dry film resist (DRF) is attached to the seed layer 22 to form a resist 23, and the resist 23 is patterned by photolithography to form through holes 24 in which the seed layer 22 is exposed in a region where the coil wiring is to be formed.

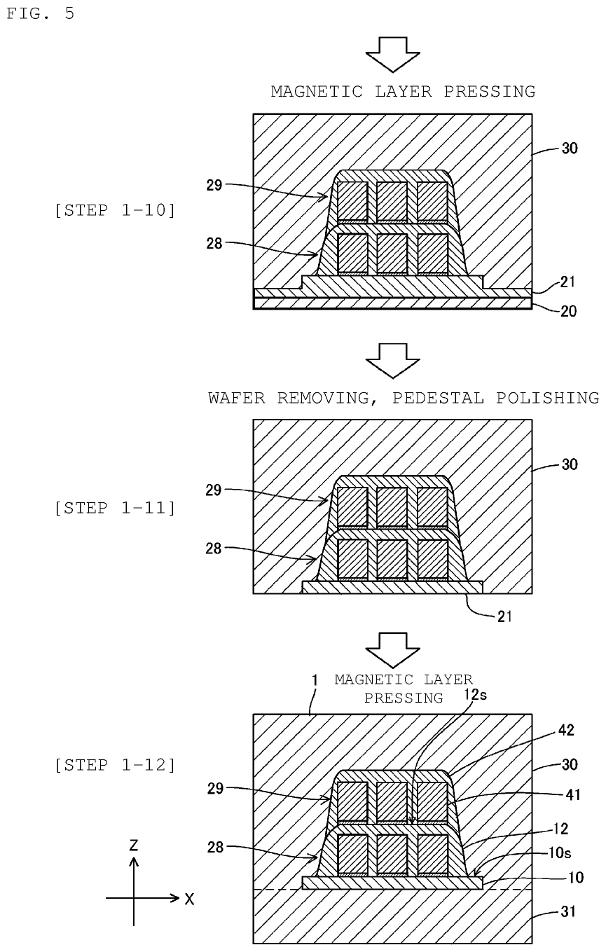

In next step 1-4 (corresponding to a first step of the present disclosure), metal films 25 are formed on the seed layer 22 in the through holes 24 by electrolytic plating. In next step 1-5, the resist 23 is peeled off. Subsequently, in step 1-6 of FIG. 4, exposed portions of the seed layer 22 where the metal films 25 are not formed are removed by etching. As a result, the coil wiring by the metal films 25 are formed on the main surface 21s of the pedestal 21 (the main surface of the base layer).

In next step 1-7 (corresponding to a second step of the present disclosure), a positive-type insulating dry film (positive-type photosensitive insulating material) is disposed on the upper surface side of the pedestal 21 in a pressure-bonded manner to form an insulating layer 26. Note that a liquid-type photosensitive insulating material may be used. In next step 1-8 (corresponding to a third step and a fourth step of the present disclosure), the insulating layer 26 is patterned by photolithography using a broadband light source, the portions other than the portion covering the coil wiring of the insulating layer 26 are removed, and the insulating layer 26 is cured by baking to form a trapezoidal insulating layer 27 having a gentle inclination.

Here, since the lower side of the insulating layer 27 is restricted by the pedestal, shrinkage in the X direction is less likely to occur than the upper side without restriction. Therefore, the insulating layer 27 has a trapezoidal shape having a gentle inclination. As described above, in the trapezoidal shape of the insulating layer 27, the inclination of the insulating layer 12 can be adjusted to a desired mode by changing the exposure condition of photolithography (exposure time, focus depth of exposure machine, etc.), the heating condition of baking (heating time, heating temperature, etc.), and the forming condition of the pedestal (formation range, material).

Next step 1-9 is a step of forming a second layer 29 on a first layer 28, and the second layer 29 is formed by repeating the above-described steps 1-1 to 1-8 using the upper surface of the first layer 28 as a base layer.

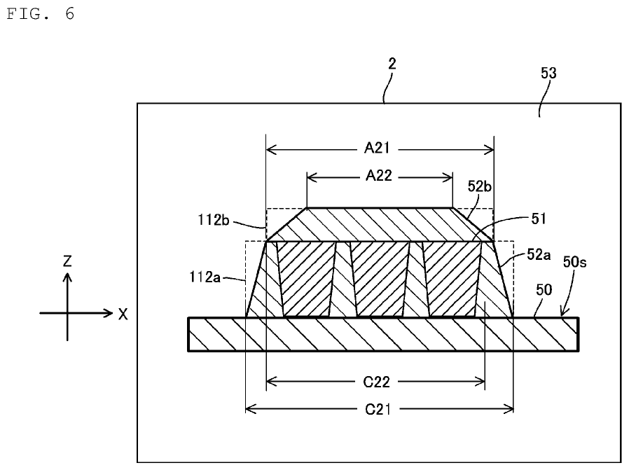

Subsequently, in step 1-10 in FIG. 5, a magnetic sheet made of a magnetic material is pressure-bonded to the upper surface side (the side on which the coil wiring is formed) of the pedestal 21. As a result, a magnetic layer 30 is formed so as to cover the insulating layers of the first layer 28 and the second layer 29. In next step 1-11, a part of the substrate 20 and a part of the pedestal 21 are removed by polishing. The remaining part of the pedestal 21 becomes a base layer of the present disclosure. In next step 1-12, a magnetic sheet made of a magnetic material is pressure-bonded to the lower surface side of the pedestal 21. As a result, a magnetic layer 31 covering the insulating layer 12 together with the magnetic layer 30 formed in step 1-11 is formed.

According to the method for manufacturing the inductor component 1, patterning by photolithography and baking are performed by pressure-bonding a positive-type insulating dry film in steps 1-7 and 1-8. As a result, as illustrated in FIG. 1, it is possible to manufacture the inductor component 1 having a shape in which the width A1 of the end surface on the upper side of the insulating layer 12 is narrower than the width C1 of the end surface on the lower side, and the width A1 is narrower than the width B1 of the portion where the coil wiring 11 is formed. Therefore, it is possible to manufacture the inductor component 1 in which the inductance value is improved as compared with the conventional product by increasing the volume occupied by the magnetic layer 13 as compared with the conventional product.

As exemplified in the above manufacturing method, the inductor component 1 may have a configuration in which the second layer is formed. More specifically, as illustrated in step 1-12 of FIG. 5, a second coil wiring 41 formed on a main surface 12s of the insulating layer 12 and a second insulating layer 42 formed on the main surface 12s of the insulating layer 12 and covering the second coil wiring 41 may be further included, and the shape of the second insulating layer 42 in the section perpendicular to the main surface 10s of the base layer 10 may be a trapezoidal shape in which the width of the first end surface on the side opposite to the base layer 10 is narrower than the width of the second end surface on the base layer 10 side, and the width of the first end surface of the second insulating layer 42 is narrower than the width of the formation area of the second coil wiring 41 in the X direction parallel to the main surface 10s of the base layer 10.

As a result, in the configuration in which the second layer is formed, the volume of the second insulating layer 42 is reduced, and the volume of the magnetic layer 30 covering the second insulating layer 42 is increased by this reduction, so that the inductance value of the inductor component 1 can be improved.

Note that the inductor component 1 may have a configuration in which a third layer or more is formed.

### 2. Second Embodiment

### (2-1. Configuration)

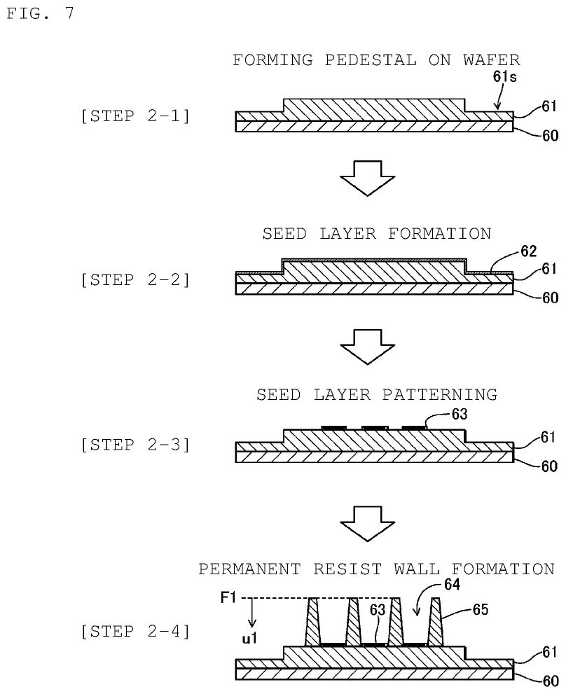

FIG. 6 is a sectional view schematically illustrating a configuration of an inductor component 2 of a second embodiment, and also illustrates a difference in configuration from a conventional product. The inductor component 2 of the second embodiment includes a base layer 50, a coil wiring 51, insulating layers 52a and 52b, and a magnetic layer 53. The coil wiring 51 is connected to an external electrode (not illustrated). In the drawing, a normal direction of the base layer 50 is defined as the Z direction, the forward Z direction is defined as the upper side, and the reverse Z direction is defined as the lower side. In FIG. 6, a direction parallel to the main surface 50s of the base layer 50 is defined as the X direction. Note that the section illustrated in FIG. 6 is a section including the center of the inductor component 2 in a direction parallel to the main surface 50s of the base layer 50 and is a section orthogonal to the extending direction of the coil wiring 51. In addition, the forward Z direction, that is, the upper side is a direction from the base layer 50 toward the coil wiring 51.

An application and a shape of the inductor component 2 are the same as those of the inductor component 1 of the first embodiment. In addition, the base layer 50, the coil wiring 51, the insulating layers 52a and 52b, and the magnetic layer 53 are made of the same materials as those of the inductor component 1 of the first embodiment, but the insulating layers 52a and 52b are made of a negative-type photosensitive insulating material as described later.

The coil wiring 51 is formed on the main surface 50s of the base layer 50 so as to extend to the upper side of the base layer 50, and is wound on the base layer 50. The coil wiring 11 has a spiral shape in which the number of turns exceeds one turn. The insulating layers 52a and 52b are layers having a shape covering the coil wiring 51. The insulating layer 52a is a wall portion covering a side portion of the coil wiring 51, and the insulating layer 52b is a lid portion covering an end portion of the coil wiring 51. The magnetic layer 53 is formed so as to cover the base layer 50 on which the coil wiring 51 is formed and the insulating layers 52a and 52b. In FIG. 6, the magnetic layer 53 is transparent.

In the inductor component 2, in the section perpendicular to the main surface 50s of the base layer 50, the insulating layer 52a (wall portion) has a tapered shape in which the width of the insulating layer 52a in the X direction parallel to the main surface 50s of the base layer 50 gradually decreases from C21 to C22 from the lower side to the upper side. The insulating layer 52b (lid portion) also has a tapered shape in which the width in the X direction gradually decreases from A21 to A22 from the lower side to the upper side.

By forming the insulating layers 52a and 52b of the inductor component 2 in the tapered shape, the volumes of the insulating layers 52a and 52b are reduced as compared with the case where the insulating layers 112a and 112b have rectangular shapes as in the conventional inductor component indicated by a dotted line in FIG. 6. Then, the volume of the magnetic layer 53 covering the insulating layers 52a and 52b is increased by this decrease. As a result, the inductance value of the inductor component 2 can be improved.

In the inductor component 2, as illustrated in FIG. 6, the wall portion 52a and the lid portion 52b are preferably separate members that are in contact with each other with an interface interposed therebetween. As a result, since the respective shapes can be adjusted independently, the shapes of the insulating layers 52a and 52b with a higher degree of freedom can be realized.

However, as in the inductor component 1, the wall portion and the lid portion may be integrated, so that the insulating layer 12 can be formed more easily.

### (2-2. Manufacturing Method)

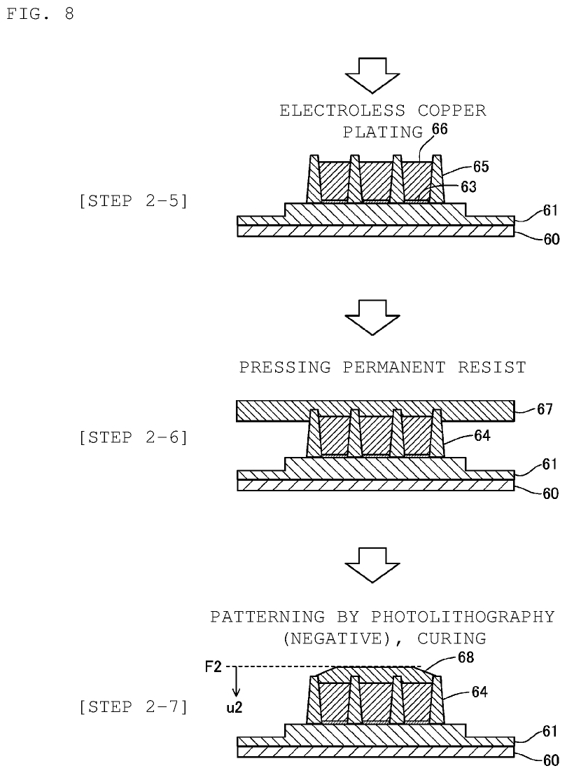

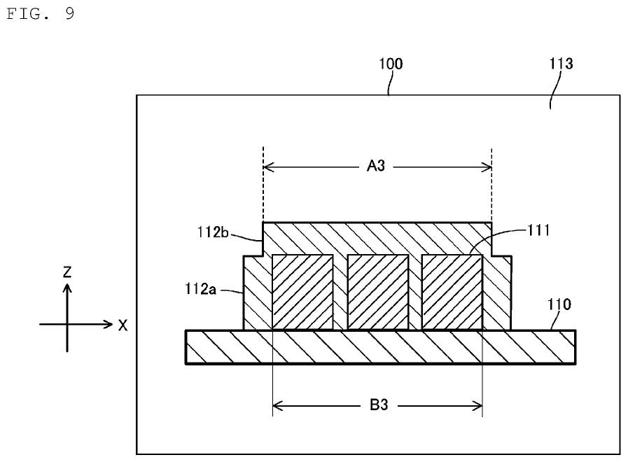

Next, a method for manufacturing the inductor component 2 will be described with reference to FIGS. 7 and 8.

First, as illustrated in step 2-1 of FIG. 7, an insulating pedestal 61 is formed on a substrate (wafer) 60. The substrate 60 is, for example, a flat plate-like substrate made of a ceramic material such as glass or ferrite, a printed wiring board material such as a resin containing glass cloth, or the like. The pedestal 61 is made of, for example, a polyimide-based resin not containing a magnetic body, and is formed on the upper surface of the substrate 60 by photolithography.

In next step 2-2, a Cu seed layer 62 is formed on a main surface 61s of the pedestal 61 by sputtering, electroless plating, or the like. In next step 2-3, patterning is performed by photolithography, and the seed layer 62 is removed while leaving regions 63 where the coil wiring is to be formed.

In next step 2-4 (corresponding to the first step and the second step of the present disclosure), a negative-type insulating dry film is pressure-bonded to the upper surface side of the pedestal 61 to form a first insulating layer, and the first insulating layer is patterned by photolithography using a broadband light source and cured by baking to form wall portions 65 (permanent resist walls) of through holes 64 having a tapered shape. Note that a liquid-type photosensitive insulating material may be used.

Here, a focus position of a projection exposure machine at the time of performing photolithography is set to be shifted downward indicated by u1 from the surface F1 of the first insulating layer. As a result, the irradiation range on the lower side of the first insulating layer is narrower than that on the upper side to form a tapered shape. In addition, similarly to the method for manufacturing the inductor component 1 of the first embodiment, the inclination of the wall portion 65 can be adjusted to a desired mode by changing the exposure condition of photolithography (exposure time, focus depth of exposure machine, etc.), the heating condition of baking (heating time, heating temperature, etc.), and the forming condition of the pedestal (formation range, material).

In subsequent step 2-5 (corresponding to the third step of the present disclosure) in FIG. 8, metal films 66 are formed on the seed layers 63 by electrolytic plating. In next step 2-6 (corresponding to the fourth step of the present disclosure), a negative-type insulating dry film as a permanent resist is pressure-bonded to the upper surface side of the pedestal 61 to form a second insulating layer 67 as a permanent resist layer. In next step 2-7 (corresponding to a fifth step of the present disclosure), patterning by photolithography and curing by baking are performed to form an insulating layer 68 to be a lid portion. Note that a liquid-type photosensitive insulating material may be used.

Also in step 2-7, similarly to step 2-4 described above, the focus position of the projection exposure machine at the time of performing photolithography is set to be shifted downward indicated by u2 from the surface F2 of the permanent resist layer 67. As a result, the irradiation range on the lower side of the permanent resist layer 67 is narrower than that on the upper side to form a tapered shape. In addition, similarly to the method for manufacturing the inductor component 1 of the first embodiment, the inclination of the insulating layer 68 as the lid portion can be adjusted to a desired mode by changing the exposure condition of photolithography (exposure time, focus depth of exposure machine, etc.), the heating condition of baking (heating time, heating temperature, etc.), and the forming condition of the pedestal (formation range, material).

Next, processes similar to steps 1-9 to 1-12 in the first embodiment are performed to complete the inductor component 2.

According to the method for manufacturing the inductor component 2, photolithography in which the focus position of the projection exposure machine is shifted downward from the surface of the insulating layer is performed on the insulating layer made of the negative-type insulating material in steps 2-4 and 2-7. As a result, as illustrated in FIG. 6, it is possible to manufacture the inductor component 2 in which the insulating layer 52a (wall portion) has a tapered shape in which the width of the insulating layer 52a in the X direction parallel to the main surface 50s of the base layer 50 gradually decreases from C21 to C22 from the lower surface to the upper surface, and the insulating layer 52b (lid portion) also has a tapered shape in which the width of the insulating layer 52b in the X direction gradually decreases from A21 to A22 from the lower surface to the upper surface. Therefore, it is possible to manufacture the inductor component 2 in which the inductance value is improved as compared with the conventional product by increasing the volume occupied by the magnetic layer 53 as compared with the conventional product.

Note that each of the above-described embodiments is merely an example of one aspect of the present disclosure, and can be arbitrarily modified and applied without departing from the gist of the present disclosure.

For example, in the inductor component 2, in steps 2-4 and 2-7, photolithography in which the focus position of the projection exposure machine is shifted upward from the surface of the insulating layer may be performed on the insulating layer made of a positive-type insulating material.

Directions such as horizontal and vertical directions, various numerical values, shapes, and materials in the above-described embodiments include a range (so-called equivalent range) in which the same functions and effects as those of the directions, numerical values, shapes, and materials are exhibited unless otherwise specified.

The number of turns of the coil wiring 11 in the above embodiments may be less than one turn, and the shape of the coil wiring 11 may be a known shape such as straight or meander.

### 3. Configuration Supported by Above Embodiments

The above-described embodiments support the following configurations. (Configuration 1) An inductor component including base layer having a main surface; coil wiring formed on the main surface of the base layer; an insulating layer covering the coil wiring; and a magnetic layer covering the insulating layer, in which a shape of the insulating layer in a section perpendicular to the main surface of the base layer is a trapezoidal shape in which a width of a first end surface on a side opposite to the base layer is narrower than a width of a second end surface on the base layer side, and the width of the first end surface is narrower than a width of a formation area of the coil wiring in a direction parallel to the main surface of the base layer.

(Configuration 2) The inductor component according to the configuration 1, in which the insulating layer is made of a positive-type photosensitive insulating material.

(Configuration 3) The inductor component according to the configuration 1 or 2, in which in the trapezoidal shape, two opposing side surfaces connecting the first end surface and the second end surface form a curved line or a polygonal line protruding toward an outside of the insulating layer.

(Configuration 4) The inductor component according to any one of the configurations 1 to 3, in which the coil wiring extends in a normal direction of the main surface of the base layer, in which the insulating layer includes a wall portion covering a side portion of the coil wiring and a lid portion covering an upper end portion of the coil wiring, and in which a shape of the insulating layer in a section perpendicular to the main surface of the base layer is a tapered shape in which a width of the insulating layer in a direction parallel to the main surface of the base layer becomes narrower as a distance increases from the base layer in both the wall portion and the lid portion.

(Configuration 5) The inductor component according to any one of the configurations 1 to 4, in which the insulating layer is made of a negative-type photosensitive insulating material.

(Configuration 6) The inductor component according to the configuration 4, in which the wall portion and the lid portion are integrated.

(Configuration 7) The inductor component according to the configuration 4, in which the wall portion and the lid portion are separate members that come into contact with each other with an interface interposed between the wall portion and the lid portion.

(Configuration 8) The inductor component according to any one of the configurations 1 to 7, further including a second coil wiring formed on a main surface of the insulating layer; and a second insulating layer formed on the main surface of the insulating layer and covering the second coil wiring, in which a shape of the second insulating layer in a section perpendicular to the main surface of the base layer is a trapezoidal shape in which a width of a first end surface on a side opposite to the base layer is narrower than a width of a second end surface on the base layer side, and the width of the first end surface is narrower than a width of a formation area of the second coil wiring in a direction parallel to the main surface of the base layer.

(Configuration 9) The inductor component according to any one of the configurations 1 to 8, in which the coil wiring has a spiral shape exceeding one turn, and in which a difference between the width of the first end surface and the width of the formation area of the coil wiring is larger than an inter-line space of the coil wiring.

(Configuration 10) The inductor component according to any one of the configurations 1 to 9, in which the width of the first end surface is narrower than the width of the formation area of the coil wiring by 10 μm or more.

(Configuration 11) The inductor component according to any one of the configurations 1 to 10, in which a difference between the width of the first end surface and the width of the second end surface is larger than a width of the coil wiring.

(Configuration 12) The inductor component according to any one of the configurations 1 to 10, in which the width of the first end surface is narrower than the width of the second end surface by 50 μm or more.

(Configuration 13) A method for manufacturing an inductor component, the method including a first step of forming a coil wiring on a main surface of a base layer; a second step of forming an insulating layer by disposing a positive-type photosensitive insulating material on the main surface of the base layer so as to cover the coil wiring; and a third step of removing a range of the insulating layer other than a portion covering the coil wiring by photolithography to make a shape of the insulating layer in a section perpendicular to the main surface of the base layer into a trapezoidal shape in which a width of a first end surface on a side opposite to the base layer is narrower than a width of a second end surface on the base layer side, and a width of the first end surface is narrower than a width of a formation area of the coil wiring in a direction parallel to the main surface of the base layer.

(Configuration 14) The method for manufacturing an inductor component according to the configuration 13, further including a fourth step of curing the insulating layer after the third step.

(Configuration 15) A method for manufacturing an inductor component, the method including a first step of forming a first insulating layer on a main surface of a base layer; a second step of forming a through hole for forming a coil wiring extending in a normal direction of the main surface of the base layer in a tapered shape in which a width of a wall portion of the through hole in a section perpendicular to the main surface of the base layer becomes narrower as a distance from the base layer increases by photolithography in which a focus position of a projection exposure machine is set to be shifted from a surface of the first insulating layer with respect to the first insulating layer; a third step of forming the coil wiring in the through hole; a fourth step of forming a second insulating layer covering the through hole; and a fifth step of forming a lid portion covering the through hole as a tapered shape in which a width of the lid portion in a direction parallel to the main surface of the base layer in a section perpendicular to the main surface of the base layer becomes narrower as a distance from the base layer increases by removing a portion other than a portion of the second insulating layer covering the through hole by photolithography in which a focus position of a projection exposure machine is set to be shifted from a surface of the second insulating layer.

What is claimed is:

1. An inductor component comprising:
a base layer having a main surface;
a coil wiring on the main surface of the base layer;
an insulating layer covering the coil wiring; and
a magnetic layer covering the insulating layer,
wherein
a shape of the insulating layer in a section perpendicular to the main surface of the base layer is a trapezoidal shape in which a width of a first end surface on a side opposite to the base layer is narrower than a width of a second end surface on the base layer side, and
the width of the first end surface is narrower than a width of a formation area of the coil wiring in a direction parallel to the main surface of the base layer.

2. The inductor component according to claim 1, wherein
the insulating layer includes a positive-type photosensitive insulating material.

3. The inductor component according to claim 1, wherein
two opposing side surfaces of the trapezoidal shape, connecting the first end surface and the second end surface, define a curved line or a polygonal line protruding toward an outside of the insulating layer.

4. The inductor component according to claim 1, wherein
the coil wiring extends in a normal direction of the main surface of the base layer,
the insulating layer includes a wall portion covering a side portion of the coil wiring and a lid portion covering an upper end portion of the coil wiring, and
a shape of the insulating layer in a section perpendicular to the main surface of the base layer is a tapered shape in which a width of the insulating layer in a direction parallel to the main surface of the base layer becomes narrower as a distance increases from the base layer in both the wall portion and the lid portion.

5. The inductor component according to claim 4, wherein
the insulating layer includes a negative-type photosensitive insulating material.

6. The inductor component according to claim 4, wherein
the wall portion and the lid portion are integrated.

7. The inductor component according to claim 4, wherein
the wall portion and the lid portion are separate members which are in contact with each other with an interface interposed between the wall portion and the lid portion.

8. The inductor component according to claim 1, further comprising:
a second coil wiring on a main surface of the insulating layer; and
a second insulating layer on the main surface of the insulating layer and covering the second coil wiring,
wherein a shape of the second insulating layer in a section perpendicular to the main surface of the base layer is a trapezoidal shape in which a width of a first end surface on a side opposite to the base layer is narrower than a width of a second end surface on the base layer side, and
the width of the first end surface is narrower than a width of a formation area of the second coil wiring in a direction parallel to the main surface of the base layer.

9. The inductor component according to claim 1, wherein
the coil wiring has a spiral shape exceeding one turn, and
a difference between the width of the first end surface and the width of the formation area of the coil wiring is larger than an inter-line space of the coil wiring.

10. The inductor component according to claim 1, wherein
the width of the first end surface is narrower than the width of the formation area of the coil wiring by 10 μm or more.

11. The inductor component according to claim 1, wherein
a difference between the width of the first end surface and the width of the second end surface is larger than a width of the coil wiring.

12. The inductor component according to claim 1, wherein
the width of the first end surface is narrower than the width of the second end surface by 50 μm or more.

13. A method for manufacturing an inductor component, the method comprising:
forming a coil wiring on a main surface of a base layer;
forming an insulating layer by disposing a positive-type photosensitive insulating material on the main surface of the base layer so as to cover the coil wiring; and
removing a range of the insulating layer other than a portion of the insulating layer covering the coil wiring by photolithography to make a shape of the insulating layer in a section perpendicular to the main surface of the base layer into a trapezoidal shape in which a width of a first end surface on a side opposite to the base layer is narrower than a width of a second end surface on the base layer side, and a width of the first end surface is narrower than a width of a formation area of the coil wiring in a direction parallel to the main surface of the base layer.

14. The method for manufacturing an inductor component according to claim 13, further comprising:
curing the insulating layer after removing the range of the insulating layer.

15. A method for manufacturing an inductor component, the method comprising:
forming a first insulating layer on a main surface of a base layer;
forming a through hole for forming a coil wiring extending in a normal direction of the main surface of the base layer in a tapered shape in which a width of a wall portion of the through hole in a section perpendicular to the main surface of the base layer becomes narrower as a distance from the base layer increases by photolithography in which a focus position of a projection exposure machine with respect to the first insulating layer is set to be shifted from a surface of the first insulating layer;
forming the coil wiring in the through hole;
forming a second insulating layer covering the through hole; and
forming a lid portion covering the through hole in a tapered shape in which a width of the lid portion in a direction parallel to the main surface of the base layer in a section perpendicular to the main surface of the base layer becomes narrower as a distance from the base layer increases by removing a portion other than a portion of the second insulating layer covering the through hole by photolithography in which a focus position of a projection exposure machine is set to be shifted from a surface of the second insulating layer.
